(19) United States
(12) Patent Application Publication
(10) Pub. No.: US 2022/0300822 A1
(43) Pub. Date: Sep. 22, 2022

(54) FORGETTING DATA SAMPLES FROM PRETRAINED NEURAL NETWORK MODELS

(71) Applicant: International Business Machines Corporation, Armonk, NY (US)

(72) Inventors: Ron SHMELKIN, Haifa (IL); Abigail GOLDSTEEN, Haifa (IL); Ariel FARKASH, Shimshit (IL)

(21) Appl. No.: 17/204,485

(22) Filed: Mar. 17, 2021

(51) Int. Cl. G06N 3/08; G06N 3/04

(52) U.S. Cl. CPC G06N 3/088; G06N 3/0454

(57) ABSTRACT

A method for forgetting data samples from a pretrained neural network (NN) model is provided. The method includes training an adversarial model to classify training data samples as members of the NN model and test data samples as non-members of the NN model. The method includes performing the following iteratively until the NN model has forgotten a specified threshold of data samples to be forgotten: (1) classifying the data samples as members or non-members using the trained adversarial model; (2) for the member data samples, determining a subset that includes data samples to be forgotten; (3) labeling the data samples within the subset as non-members and updating the NN model based on weight update techniques that cause the NN model to forget the data samples; (4) retraining the NN model without the data samples that have been forgotten; and (5) retraining the adversarial model for the next iteration.

### BACKGROUND

The present disclosure relates to the field of machine learning. More specifically, the present disclosure relates to systems and methods for forgetting data samples from pretrained neural network models.

### SUMMARY

According to an embodiment described herein, a computer-implemented method is provided for forgetting data samples from a pretrained neural network model. The method includes receiving, at a computing system, a pretrained neural network model, training data samples corresponding to a training dataset for the pretrained neural network model, test data samples corresponding to a test dataset, and data samples to be forgotten from the pretrained neural network model. The method also includes training an adversarial model to classify the training data samples as members of the pretrained neural network model and the test data samples as non-members of the pretrained neural network model. The method further includes performing the following in an iterative manner until the pretrained neural network model has forgotten at least a specified threshold of the data samples to be forgotten. First, each data sample is classified as either a member or a non-member of the pretrained neural network model using the trained adversarial model. Second, for the data samples that are classified as members of the pretrained neural network model, a subset of the data samples that includes data samples to be forgotten is determined. Third, the following is performed for the subset of the data samples that includes data samples to be forgotten: (1) each data sample within the subset of data samples is labeled as a non-member; and (2) the pretrained neural network model is updated based on weight update techniques that cause the pretrained neural network model to forget the data samples within the subset of data samples. Fourth, the pretrained neural network model is retrained using at least a portion of the training data samples without the data samples that have been forgotten. Fifth, the adversarial model is retrained to classify the training data samples without the data samples that have been forgotten as members of the pretrained neural network model and the test data samples as non-members of the pretrained neural network model.

In some embodiments, the method includes training and retraining the adversarial model using attributes extracted from the pretrained neural network model. In such embodiments, this may include extracting at least one of logits and/or probabilities from a last layer of the pretrained neural network model, activation from any layer of the pretrained neural network model, or weights and/or gradients from the pretrained neural network model, as well as using the at least one of the extracted logits and/or probabilities, activation, or weights and/or gradients to train the adversarial model.

In various embodiments, classifying each data sample as either a member or a non-member of the pretrained neural network model using the trained adversarial model includes performing the following for each data sample: (1) extracting features of the data sample; (2) utilizing the adversarial model to determine whether the features of the data sample correspond to the training data samples; (3) if the features of the data sample do not correspond to the training data samples, classifying the data sample as a non-member of the pretrained neural network model; and (4) if the features of the data sample do correspond to the training data samples, classifying the data sample as a member of the pretrained neural network model. Moreover, in some embodiments, the method includes retraining the pretrained neural network model using additional data samples that are similar to the training data samples, either alone or in combination with at least a portion of the training data samples without the data samples that have been forgotten.

In some embodiments, the method includes predetermining the specified threshold of the data samples to be forgotten. In other embodiments, the method includes determining the specified threshold of the data samples to be forgotten based on a classification distribution of the test data samples by the adversarial model. Moreover, in various embodiments, the method includes classifying the data samples, determining the subset of the data samples, and performing the labeling of the data samples and the updating of the pretrained neural network model in a repetitive manner on batches of data samples, wherein each batch of data samples includes any combination of training data samples, test data samples, and data samples to be forgotten.

In another embodiment, a computing system is provided. The computing system includes an interface for receiving a pretrained neural network model, training data samples corresponding to a training dataset for the pretrained neural network model, test data samples corresponding to a test dataset, and data samples to be forgotten from the pretrained neural network model. The computing system also includes a processor and a computer-readable storage medium. The computer-readable storage medium stores program instructions that direct the processor to train an adversarial model to classify training data samples as members of the pretrained neural network model and test data samples as non-members of the pretrained neural network model. The computer-readable storage medium also stores program instructions that direct the processor to perform the following in an iterative manner until the pretrained neural network model has forgotten at least a specified threshold of the data samples to be forgotten. First, each data sample is classified as either a member or a non-member of the pretrained neural network model using the trained adversarial model. Second, for the data samples that are classified as members of the pretrained neural network model, a subset of the data samples that includes data samples to be forgotten is determined. Third, the following is performed for the subset of the data samples that includes data samples to be forgotten: (1) each data sample within the subset of data samples is labeled as a non-member; and (2) the pretrained neural network model is updated based on weight update techniques that cause the pretrained neural network model to forget the data samples within the subset of data samples. Fourth, the pretrained neural network model is retrained using at least a portion of the training data samples without the data samples that have been forgotten. Fifth, the adversarial model is retrained to classify the training data samples without the data samples that have been forgotten as members of the pretrained neural network model and the test data samples as non-members of the pretrained neural network model.

In some embodiments, the computer-readable storage medium stores program instructions that direct the processor to train and retrain the adversarial model using attributes extracted from the pretrained neural network model. In such embodiments, this may include extracting at least one of logits and/or probabilities from a last layer of the pretrained neural network model, activation from any layer of the pretrained neural network model, or weights and/or gradients from the pretrained neural network model, as well as using the at least one of the extracted logits and/or probabilities, activation, or weights and/or gradients to train the adversarial model.

In various embodiments, the computer-readable storage medium stores program instructions that direct the processor to classify each data sample as either a member or a non-member of the pretrained neural network model using the trained adversarial model by performing the following for each data sample: (1) extracting features of the data sample; (2) utilizing the adversarial model to determine whether the features of the data sample correspond to the training data samples; (3) if the features of the data sample do not correspond to the training data samples, classifying the data sample as a non-member of the pretrained neural network model; and (4) if the features of the data sample do correspond to the training data samples, classifying the data sample as a member of the pretrained neural network model. Moreover, in some embodiments, the computer-readable storage medium stores program instructions that direct the processor to retrain the pretrained neural network model using additional data samples that are similar to the training data samples, either alone or in combination with at least a portion of the training data samples without the data samples that have been forgotten.

In some embodiments, the computer-readable storage medium stores program instructions that direct the processor to predetermine the specified threshold of the data samples to be forgotten. In other embodiments, the computer-readable storage medium stores program instructions that direct the processor to determine the specified threshold of the data samples to be forgotten based on a classification distribution of the test data samples by the adversarial model. Furthermore, in various embodiments, the computer-readable storage medium stores program instructions that direct the processor to classify the data samples, determine the subset of the data samples, and perform the labeling of the data samples and the updating of the pretrained neural network model in a repetitive manner on batches of data samples, wherein each batch of data samples includes any combination of training data samples, test data samples, and data samples to be forgotten.

In yet another embodiment, a computer program product is provided. The computer program product includes a computer-readable storage medium having program instructions embodied therewith, wherein the computer-readable storage medium is not a transitory signal per se. The program instructions are executable by a processor to cause the processor to access a pretrained neural network model, training data samples corresponding to a training dataset for the pretrained neural network model, test data samples corresponding to a test dataset, and data samples to be forgotten from the pretrained neural network model. The program instructions are also executable by the processor to cause the processor to train an adversarial model to classify training data samples as members of the pretrained neural network model and test data samples as non-members of the pretrained neural network model. The program instructions are further executable by the processor to cause the processor to perform the following in an iterative manner until the pretrained neural network model has forgotten at least a specified threshold of the data samples to be forgotten. First, each data sample is classified as either a member or a non-member of the pretrained neural network model using the trained adversarial model. Second, for the data samples that are classified as members of the pretrained neural network model, a subset of the data samples that includes data samples to be forgotten is determined. Third, the following is performed for the subset of the data samples that includes data samples to be forgotten: (1) each data sample within the subset of data samples is labeled as a non-member; and (2) the pretrained neural network model is updated based on weight update techniques that cause the pretrained neural network model to forget the data samples within the subset of data samples. Fourth, the pretrained neural network model is retrained using at least a portion of the training data samples without the data samples that have been forgotten. Fifth, the adversarial model is retrained to classify the training data samples without the data samples that have been forgotten as members of the pretrained neural network model and the test data samples as non-members of the pretrained neural network model.

In various embodiments, the program instructions are executable by the processor to cause the processor to train and retrain the adversarial model using attributes extracted from the pretrained neural network model. In such embodiments, this may include extracting at least one of logits and/or probabilities from a last layer of the pretrained neural network model, activation from any layer of the pretrained neural network model, or weights and/or gradients from the pretrained neural network model, as well as using the at least one of the extracted logits and/or probabilities, activation, or weights and/or gradients to train the adversarial model.

In various embodiments, the program instructions are executable by the processor to cause the processor to classify each data sample as either a member or a non-member of the pretrained neural network model using the trained adversarial model by performing the following for each data sample: (1) extracting features of the data sample; (2) utilizing the adversarial model to determine whether the features of the data sample correspond to the training data samples; (3) if the features of the data sample do not correspond to the training data samples, classifying the data sample as a non-member of the pretrained neural network model; and (4) if the features of the data sample do correspond to the training data samples, classifying the data sample as a member of the pretrained neural network model. Moreover, in some embodiments, the program instructions are executable by the processor to cause the processor to retrain the pretrained neural network model using additional data samples that are similar to the training data samples, either alone or in combination with at least a portion of the training data samples without the data samples that have been forgotten.

In some embodiments, the program instructions are executable by the processor to cause the processor to predetermine the specified threshold of the data samples to be forgotten. In other embodiments, the program instructions are executable by the processor to cause the processor to determine the specified threshold of the data samples to be forgotten based on a classification distribution of the test data samples by the adversarial model. Furthermore, in various embodiments, the program instructions are executable by the processor to cause the processor to classify the data samples, determine the subset of the data samples, and perform the labeling of the data samples and the updating of the pretrained neural network model in a repetitive manner on batches of data samples, wherein each batch of data samples includes any combination of training data samples, test data samples, and data samples to be forgotten.

### BRIEF DESCRIPTION OF THE SEVERAL VIEWS OF THE DRAWINGS

FIG. 1 is a schematic view of an exemplary representation of an adversarial model training phase of the adversarial-based data forgetting techniques described herein;

FIG. 2 is a schematic view of an exemplary representation of a data forgetting phase of the adversarial-based data forgetting techniques described herein;

FIG. 3 is a schematic view of an exemplary representation of a neural network model retraining phase of the adversarial-based data forgetting techniques described herein;

FIG. 4 is a process flow diagram of a method for forgetting data samples from a pretrained neural network model;

FIG. 5 is a simplified block diagram of an exemplary computing system that can be used to implement the adversarial-based data forgetting techniques described herein;

FIG. 6 is a schematic view of an exemplary cloud computing environment that can be used to implement the adversarial-based data forgetting techniques described herein; and

FIG. 7 is a simplified schematic view of exemplary functional abstraction layers provided by the cloud computing environment shown in FIG. 6 according to embodiments described herein.

### DETAILED DESCRIPTION

Due to rapid advancements in the field of machine learning, software system designers and application developers are increasingly relying on machine learning models to perform complex tasks. Often, such machine learning models are trained using large datasets that include sensitive data, such as personal data collected from particular users. Such personal data may include, for example, personal photos, office documents, medical records, personal emails, or logs of user clicks on a website or mobile device. Moreover, the training process involves using such sensitive data to perform complex computations to derive even more data. For example, sensitive data may be copied to one or more backup locations, aggregated with other similar data, and analyzed to extract properties or features. As a result, the raw data typically goes through a series of computations and, thus, appears within the model's complex data propagation network in many places and forms.

Conversely, users in today's world are becoming more concerned about the unfettered distribution of their personal data. In many cases, users wish to have their personal data completely erased from particular platforms. In addition, legislation has been recently introduced to address this concern. For example, the European General Data Protection Regulation (GDPR) grants individuals the so-called “right to be forgotten,” which includes the right to withdraw consent to the processing of personal data, as well as to have such personal data deleted from an organization's data stores.

Furthermore, conventional machine learning techniques are generally designed under the assumption that sensitive data employed during the training of a machine learning model will not be subject to abuse at runtime. However, with the growing number of applications that employ machine learning models built upon this assumption, machine learning models themselves are increasingly targets of attacks from malicious adversaries seeking to access the sensitive training data. Such attacks include both black-box attacks in which data is extracted by observing only the model inputs and outputs and white-box attacks in which data is extracted using direct knowledge of the model topology, parameters, and weights. Moreover, recent attacks, such as, in particular, recent black-box membership and attribute inference attacks, have proven that personal data is present within, and can be extracted from, machine learning models. This has led some experts to conclude that machine learning models themselves can be considered personal information and, thus, are subject to the GDPR and other similar laws. This creates a significant problem for companies that employ machine learning models, since it is generally difficult to delete particular data samples from such models due to the complex data propagation network that is used to create the models.

Several techniques have been proposed to address this problem. However, such techniques generally assume some control over the data extraction and/or training process, and do not provide for the removal of data from existing, already-trained models. Moreover, the few techniques that have attempted to provide for the removal of data from trained models are generally incomplete in that they do not provide for the removal of the data from the model weights and, thus, the data may still be capable of being extracted during white-box attacks. In addition, such techniques are computationally difficult since they typically rely on complex calculations, such as complex calculations relating to the Hessian or Fisher Information Matrices of the trained models. Furthermore, such techniques generally result in a relatively high accuracy hit for the modified model, where the term “accuracy hit” refers to the loss in accuracy (in percentage points) for the modified model as compared to the original model. Accordingly, there is a need for improved techniques for forgetting data from trained machine learning models.

Therefore, embodiments described herein provide improved techniques for forgetting data samples from trained machine learning models. Specifically, such techniques utilize adversarial training methods to forget sensitive data from pretrained neural network models, where a particular data sample is determined to be “forgotten” from a model if any adversary with black-box and/or white-box access to the model is not able to determine whether the data sample was used to train the model or not. According to embodiments described herein, data samples are forgotten from such models without making any assumptions about the manner in which the models were trained. In addition, such techniques do not require any complex calculations or approximations. Moreover, such techniques result in a very low accuracy hit as compared to previous techniques for forgetting data samples from trained models.

Adversarial training methods are based on a min-max game between two models that are posed against each other (i.e., as adversaries). For example, in generative adversarial networks, the discriminator model tries to classify data samples correctly, e.g., as real or fake samples. Meanwhile, the generator model may try to generate data samples that the discriminator model will misclassify. According to embodiments described herein, such adversarial training methods are utilized to enable the removal of data samples from a pretrained neural network model. In particular, according to embodiments described herein, the adversarial model determines whether particular data samples to be forgotten are present within the training dataset for the neural network model. Meanwhile, the neural network model updates the model parameters (i.e., weights) such that the data samples are forgotten from the model, thus trying to prevent the adversarial model from classifying the data samples to be forgotten as being present within the training dataset. In addition, the neural network model performs epochs of retraining after portions of the data samples to be forgotten have been removed.

According to embodiments described herein, an adversarial model, D, is used to force the neural network model to forget particular data samples. Specifically, according to embodiments described herein, it is determined that a neural network model remembers the training data if an adversarial model, D, can distinguish between the test data and the training data with non-negligible advantage over a random coin flip. By using adversarial training to classify whether the data sample belongs to the training dataset or not, the neural network model is forced to react to data samples that are to be forgotten in the same manner as data samples from the test dataset. This process is known as “data forgetting.” To maximize model accuracy, this data forgetting process is performed iteratively with retraining of the neural network model on a portion of the training dataset (and/or another similar dataset) that includes data samples that do not need to be forgotten, where this neural network model retraining phase is performed independently of the adversarial model.

While embodiments described herein generally relate to the implementation of the present techniques for neural network models, it will be appreciated by one of skill in the art that the present techniques may also be adapted for any other suitable type(s) of machine learning models. In addition, while embodiments described herein relate to the use of the present techniques for forgetting personal or sensitive data from pretrained models (e.g., to provide for GDPR compliance), it will be appreciated by one of skill in the art that the present techniques can also be used to forget any other suitable type(s) of data from such models.

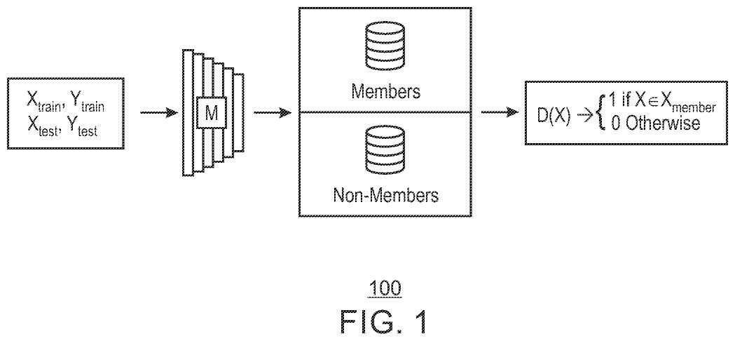

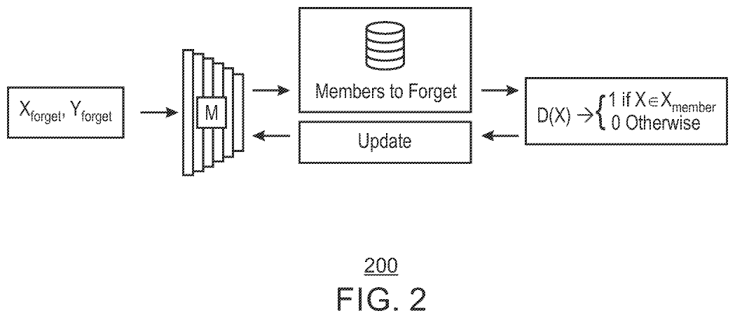

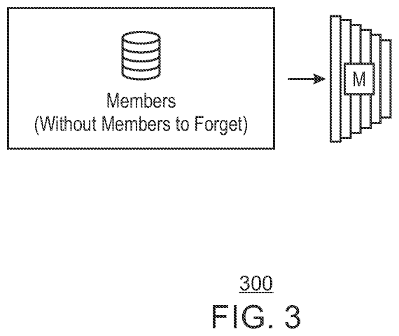

Turning now to the details of the adversarial-based data forgetting techniques described herein, given a pretrained neural network model (M), the model training dataset (Xₜᵣₐᵢₙ, Yₜᵣₐᵢₙ), a test dataset (Xₜₑₛₜ, Yₜₑₛₜ), and data that needs to be forgotten (X_{forget},Y_{forget}), the adversarial-based data forgetting techniques described herein can be divided into two parts. The first part includes the adversarial model training phase, which is described with respect to FIG. 1. In various embodiments, the adversarial model training phase is used to train the adversarial model D such that it is able to determine whether each data sample is a “member” of the pretrained neural network model (meaning that the data sample was used in the training dataset for the neural network model) or a “non-member” of the pretrained neural network model (meaning that the data sample was not used in the training dataset for the neural network model). The second part includes the data forgetting phase and the neural network model retraining phase, as described with respect to FIGS. 2 and 3, respectively. In various embodiments, the data forgetting phase is used to forget particular data samples from the neural network model, while the neural network model retraining phase is used to retrain the neural network model without the data samples that have been forgotten. Moreover, the data forgetting phase and the neural network model retraining phase are performed iteratively to maximize the model accuracy.

FIG. 1 is a schematic view of an exemplary representation of an adversarial model training phase 100 of the adversarial-based data forgetting techniques described herein. In various embodiments, the adversarial model training phase 100 trains the adversarial model D such that it is able to determine whether each data sample is present in the training dataset or the test dataset. In various embodiments, this is accomplished by training D on the reaction of the pretrained model M to the data samples.

In various embodiments, the adversarial model D uses the logits extracted from the pretrained model M's last layer for this purpose. However, one skilled in the art will appreciate that the adversarial model training phase 100 can also be performed using other attributes that can be extracted from the pretrained model M, regardless of whether those attributes represent black-box or white-box data. For example, the adversarial model training phase 100 can also be executed using the loss, gradients, probabilities, or the like, corresponding to the pretrained model M.

As shown in FIG. 1, during the adversarial model training phase 100, a set of data samples, which includes data samples from the model training dataset (i.e., Xₜᵣₐᵢₙ,Yₜᵣₐᵢₙ) (i.e., may also include training data samples to be forgotten) and data samples from the test dataset (i.e., Xₜₑₛₜ, Yₜₑₛₜ), are input to the pretrained neural network model M. In some embodiments, the training data samples are selected from the full training dataset while, in other embodiments, the training data samples are selected from a partial training dataset. In addition, the test data samples may be selected from a public or synthetic test dataset, depending on the details of the specific implementation. Moreover, as described herein, the data samples selected from the test dataset are used as non-member samples for the adversarial model training phase 100.

Once the data samples (i.e., Xᵣₐᵢₙ, Yₜᵣₐᵢₙ, Xₜₑₛₜ,Yₜₑₛₜ) are input to the model M, the adversarial model D is trained to classify whether each data sample (x) is a member of the training dataset, in which case D (X)=1, meaning that X∈X_{member}, or a non-member of the training dataset, in which chase D (X)=0. In this manner, the member data samples (Xₜᵣₐᵢₙ, Yₜᵣₐᵢₙ) and the non-member data samples (Xₜₑₛₜ, Yₜₑₛₜ) are utilized to produce an adversarial model D that can effectively determine whether a data sample is present within the model M.

FIG. 2 is a schematic view of an exemplary representation of a data forgetting phase 200 of the adversarial-based data forgetting techniques described herein. In various embodiments, the data forgetting phase 200 is used to remove a particular set of data samples to be forgotten (i.e., X_{forget},Y_{forget}) from the model M. In various embodiments, this is accomplished by first extracting the features (e.g., logits) of each data sample to be forgotten, where each data sample's features are designated as r, and all the relevant features for the data samples to be forgotten are designated as R_{forget} (i.e., r∈R_{forget}) Next, for each data sample in (X_{forget},Y_{forget}), it is determined whether the data sample's features, r, should be classified as a member or a non-member of the model M. In various embodiments, this is accomplished via an adversarial model D to determine whether the data sample was used as part of the training dataset for the neural network model M. Specifically, as shown in FIG. 2, if the adversarial model D determines that the data sample (x) is present within the training dataset (i.e., D(r)=1), then the corresponding data sample (x) is classified as a member (meaning that x∈X_{member}) Conversely, if the adversarial model D determines that the data sample is not present within the training dataset (i.e., D(r)=0), then the corresponding data sample (x) is classified as a non-member (meaning that x∈X_{nonmember}).

Next, the adversarial model D identifies all the data samples that have been classified as members, and then determines a subset of those data samples that includes data samples that are to be forgotten. The neural network model M is then updated based on the changes required to cause the adversarial model to classify the data samples within the subset as non-members. This is done by first changing the labels of the data samples to non-members and then back-propagating the required changes up to the input of the adversarial model D, thus forcing the condition D(r)=0 (and, thus, x∈Xₙₒₙ_{_{member}}). Since the input of the adversarial model D is also the output of (or some other attribute extracted from) the neural network model M, these changes can continue to be back-propagated to update the weights of the neural network model M, meaning that the data samples within the subset are effectively removed (or forgotten) from the neural network model M.

FIG. 3 is a schematic view of an exemplary representation of a neural network model retraining phase 300 of the adversarial-based data forgetting techniques described herein. According to embodiments described herein, the neural network model retraining phase is performed iteratively with the data forgetting phase 200 to retrain the model M on the remaining data samples within the training dataset (Xₜᵣₐᵢₙ, Yₜᵣₐᵢₙ) (or, in some cases, a portion of such data samples or other data samples from a similar distribution) after the data samples to be forgotten (X_{forget},Y_{forget}) are progressively removed from the model. In other words, the model M is iteratively retrained using the dataset Xᵣₑₛₜ, Yᵣₑₛₜ(Xₜᵣₐᵢₙ\X_{forget},Yₜᵣₐᵢₙ\Y_{forget}) and/or using new, similar training data samples X_{train_new}, Y_{train_new} In various embodiments, performing the data forgetting phase 200 and the neural network model retraining phase 300 in this iterative manner based on adversarial training methods allows the model accuracy to be maximized.

Furthermore, according to embodiments described herein, this iterative process is repeated until the number of data samples within the set of data samples to be forgotten (i.e., X_{forget},Y_{forget}) that the adversarial model D still classifies as members is less than a specified threshold, where the specified threshold may be predetermined or dynamically calculated as the process progresses. For example, in some embodiments, this threshold is determined based on the classification distribution of the test dataset (e.g., based on the rate at which the adversarial model D misclassifies data samples within the test dataset as members).

In various embodiments, because the adversarial-based data forgetting techniques described herein are not applied during the original training phase, such techniques do not originally impact the model accuracy as long as forgetting is not required. In general, there are two main factors that affect the model's accuracy during any data forgetting process: (1) the relative importance of the data samples that are to be forgotten; and (2) the impact of the data forgetting process itself. Because the importance of the data samples themselves cannot be controlled, the overall goal is to produce a retrained model that is as accurate as a model trained from scratch without the forgotten samples, and to produce such a model more efficiently (i.e., in less time and/or with less computational resources) than would be required to retrain the model from scratch. According to embodiments described herein, this level of accuracy is achieved by performing the neural network model retraining phase 300 iteratively with the data forgetting phase 200, thus allowing data samples to be efficiently forgotten from the model with little to no impact on the model's accuracy. In particular, while previous data forgetting techniques generally result in a high accuracy hit, the techniques described herein have been shown to result in a much lower accuracy hit. Moreover, the techniques described herein allow the model to be effectively retrained to remove the data samples to be forgotten using much fewer epochs than would be required to retrain the model from scratch without such data samples. Accordingly, the techniques described herein provide a significant improvement over currently-available techniques for removing data samples from neural network models.

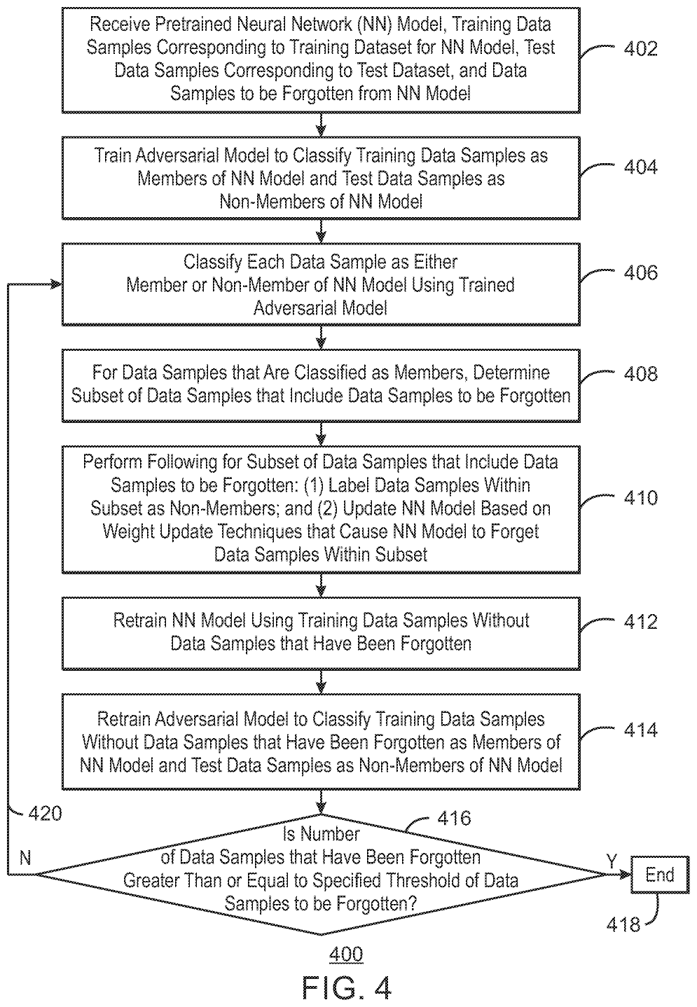

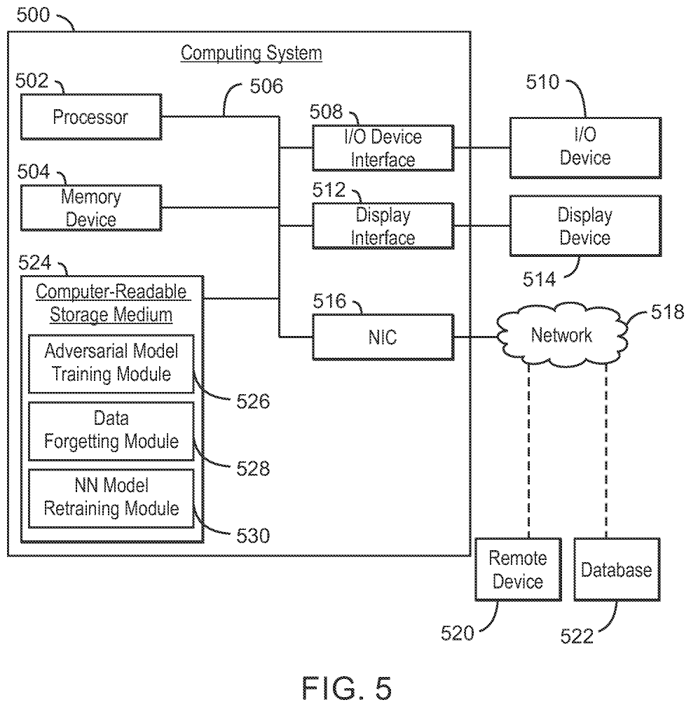

FIG. 4 is a process flow diagram of a method 400 for forgetting data samples from a pretrained neural network model. In various embodiments, the method 400 is implemented by a computing system, such as the computing system 500 described with respect to FIG. 5. In particular, the method 400 may be performed by one or more processors via the execution of one or more modules stored within one or more computer-readable storage media, as described further with respect to FIG. 5.

The method 400 begins at block 402, at which a pretrained neural network model, training data samples corresponding to a training dataset for the pretrained neural network model, test data samples corresponding to a test dataset, and data samples to be forgotten from the pretrained neural network model are received at a computing system (and accessed by the processor of the computing system). In some embodiments, the training data samples include all the data samples within the training dataset. However, in other embodiments, the training data samples include a subset of the data samples within the training dataset, particularly for embodiments in which the entire training dataset is not readily available. Moreover, in some embodiments, the data samples to be forgotten include personal or sensitive data samples corresponding to a particular user, for example, that the user has requested to have removed from an organization's data stores.

At block 404, an adversarial model is trained to classify training data samples as members of the pretrained neural network model and test data samples as non-members of the pretrained neural network model. In various embodiments, this is accomplished using attributes extracted from the pretrained neural network model. In such embodiments, this may include extracting at least one of logits and/or probabilities from a last layer of the pretrained neural network model, activation from any layer of the pretrained neural network model, or weights and/or gradients from the pretrained neural network model, as well as using the extracted logits and/or probabilities, activation, and/or weights and/or gradients to train the adversarial model.

In various embodiments, once the adversarial model has been trained on the initial dataset, an iterative process is performed until the number of data samples that have been forgotten from the neural network model is greater than or equal to a specified threshold of data samples to be forgotten. This iterative process is described below with respect to blocks 404-416 of the method 400.

At block 406, each data sample is classified as either a member or a non-member of the pretrained neural network model using the trained adversarial model. In various embodiments, this includes performing the following for each data sample: (1) extracting features of the data sample; (2) utilizing the adversarial model to determine whether the features of the data sample correspond to the training data samples; (3) if the features of the data sample do not correspond to the training data samples, classifying the data sample as a non-member of the pretrained neural network model; and (4) if the features of the data sample do correspond to the training data samples, classifying the data sample as a member of the pretrained neural network model.

At block 408, for the data samples that are classified as members of the pretrained neural network model, a subset of the data samples that includes data samples to be forgotten is determined. Next, at block 410, the following is performed for the subset of the data samples that includes data samples to be forgotten: (1) the data samples within the subset of data samples are labeled as non-members; and (2) the pretrained neural network model is updated based on weight update techniques that cause the pretrained neural network model to forget the data samples within the subset of data samples. Moreover, in various embodiments, blocks 406-410 are performed repetitively on batches of data samples, where each batch of data samples includes any combination of training data samples, test data samples, and data samples to be forgotten.

At block 412, the neural network model is retrained using at least a portion of the training data samples (and/or additional, similar data samples) without the data samples that have been forgotten. At block 414, the adversarial model is retrained to classify training data samples without the data samples that have been forgotten as members of the neural network model and test data samples as non-members of the neural network model. In various embodiments, this is accomplished in a similar manner as the training of the adversarial model at block 404, e.g., using attributes extracted from the retrained version of the neural network model. In such embodiments, this may include extracting at least one of logits and/or probabilities from a last layer of the neural network model, activation from any layer of the neural network model, or weights and/or gradients from the pretrained neural network model, as well as using the extracted logits and/or probabilities, activation, and/or weights and/or gradients to train the adversarial model.

At block 416, a determination is made about whether the number of data samples that have been forgotten from the neural network model is greater than or equal to the specified threshold of data samples to be forgotten. If the answer is “yes,” the method 400 ends at block 418. However, if the answer is “no,” then the method 400 returns to block 406 and begins another iteration, as indicated by arrow 420. In this manner, the method 400 continues until an acceptable number of data samples to be forgotten have been successfully removed from the neural network model. Moreover, in some embodiments, this acceptable number of data samples (i.e., the specified threshold) is predetermined before the method 400 is executed, while, in other embodiments, it is dynamically determined based on a classification distribution of the test data samples by the adversarial model.

The block diagram of FIG. 4 is not intended to indicate that the blocks 402-416 of the method 400 are to be executed in any particular order, or that all of the blocks 402-416 of the method 400 are to be included in every case. Moreover, any number of additional blocks may be included within the method 400, depending on the details of the specific implementation.

FIG. 5 is a simplified block diagram of an exemplary computing system 500 that can be used to implement the adversarial-based data forgetting techniques described herein. The computing system 500 may include one or more servers, one or more general-purpose computing devices, one or more special-purpose computing devices, one or more virtual machines, and/or any other suitable type(s) of computing device(s). As an example, the computing system 500 may be a desktop computer, a laptop computer, a tablet computer, or a smartphone. Moreover, in some embodiments, the computing system 500 is a cloud computing node.

The computing system 500 includes a processor 502 that is adapted to execute stored program instructions, such as program modules, as well as a memory device 504 that provides temporary memory space for the program instructions during execution. The processor 502 can include any suitable processing unit or device, such as, for example, a single-core processor, a single-core processor with software multithread execution capability; a multi-core processor, a multi-core processor with software multithread execution capability, a computing cluster, parallel platforms, parallel platforms with shared memory, or any number of other configurations. Moreover, the processor 502 can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combinations thereof, designed to perform the functions described herein. The memory device 504 can include volatile memory components, nonvolatile memory components, or both volatile and nonvolatile memory components. Nonvolatile memory components may include, for example, read only memory (ROM), programmable ROM (PROM), electrically programmable ROM (EPROM), electrically erasable ROM (EEROM), flash memory, or nonvolatile random-access memory (RAM) (e.g., ferroelectric RAM (FeRAM). Volatile memory components may include, for example, RAM, which can act as external cache memory. RAM is available in many forms, such as, for example, synchronous RAM (SRAM), dynamic RAM (DRAM), synchronous dynamic RAM (SDRAM), and the like.

In some embodiments, the computing system 500 is practiced in a distributed cloud computing environment where tasks are performed by remote processing devices that are linked through a communications network. In a distributed cloud computing environment, program modules may be located in both local and remote computing devices.

The processor 502 is connected through a system interconnect 506 (e.g., PCI®, PCI-Express®, etc.) to an input/output (I/O) device interface 508 adapted to connect the computing system 500 to one or more I/O devices 510. The I/O devices 510 may include, for example, a keyboard and a pointing device, where the pointing device may include a touchpad or a touchscreen, among others. The I/O devices 510 may include built-in components of the computing system 500 and/or devices that are externally connected to the computing system 500.

The processor 502 is also linked through the system interconnect 506 to a display interface 512 adapted to connect the computing system 500 to a display device 514. The display device 514 may include a display screen that is a built-in component of the computing system 500. The display device 514 may also include a computer monitor, television, or projector, among others, that is externally connected to the computing system 500. In addition, a network interface controller (NIC) 516 is adapted to connect the computing system 500 through the system interconnect 506 to the network 518. In some embodiments, the NIC 516 can transmit data using any suitable interface or protocol, such as the internet small computer system interface, among others. The network 518 may be a cellular network, a radio network, a wide area network (WAN), a local area network (LAN), or the Internet, among others. The network 518 may include associated copper transmission cables, optical transmission fibers, wireless transmission devices, routers, firewalls, switches, gateway computers, edge servers, and the like.

One or more remote devices 520 may optionally connect to the computing system 500 through the network 518. In addition, one or more databases 522 may optionally connect to the computing system 500 through the network 518. In some embodiments, the one or more databases 522 store data relating to machine learning tasks. For example, the database(s) 522 may include information relating to a pretrained neural network model, such as a training dataset and a test dataset corresponding to the model. In such embodiments, the computing system 500 may access or download at least a portion of the training dataset and the test dataset during the adversarial-based data forgetting process described herein.

The computing system 500 also includes a computer-readable storage medium (or media) 524 that includes program instructions that may be executed by the processor 502 to perform various operations, such as the adversarial-based data forgetting process described herein. The computer-readable storage medium 524 may be integral to the computing system 500, or may be an external device that is connected to the computing system 500 when in use. The computer-readable storage medium 524 may include, for example, an electronic storage device, a magnetic storage device, an optical storage device, an electromagnetic storage device, a semiconductor storage device, or any suitable combination of the foregoing. A non-exhaustive list of more specific examples of the computer-readable storage medium 524 includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. Moreover, the term “computer-readable storage medium,” as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. In some embodiments, the NIC 516 receives program instructions from the network 518 and forwards the program instructions for storage in the computer-readable storage medium 524 within the computing system 500.

Generally, the program instructions, including the program modules, may include routines, programs, objects, components, logic, data structures, and so on that perform particular tasks or implement particular abstract data types. For example, the program instructions may include assembler instructions, instruction-set-architecture (ISA) instructions, machine instructions, machine-dependent instructions, microcode, firmware instructions, state-setting data, or either source code or object code written in any combination of one or more programming languages, including an object-oriented programming language such as Smalltalk, C++, or the like, and conventional procedural programming languages, such as the “C” programming language or similar programming languages. The program instructions may execute entirely on the computing system 500, partly on the computing system 500, as a stand-alone software package, partly on the computing system 500 and partly on a remote computer or server connected to the computing system 500 via the network 518, or entirely on such a remote computer or server. In some embodiments, electronic circuitry including, for example, programmable logic circuitry, field-programmable gate arrays (FPGA), or programmable logic arrays (PLA) may execute the program instructions by utilizing state information of the program instructions to personalize the electronic circuitry, in order to perform aspects of the adversarial-based data forgetting process described herein.

According to embodiments described herein, the computer-readable storage medium 524 includes one or more program modules (and/or sub-modules) for performing the adversarial-based data forgetting process described herein. Specifically, the computer-readable storage medium 524 includes an adversarial model training module 526 for training an adversarial model such that it is able to accurately determine whether particular data samples are present within the training dataset or the test dataset, a data forgetting module 528 for iteratively forgetting particular data samples from the neural network model, and a neural network model retraining module 530 for iteratively retraining the neural network model without the data samples that have been forgotten. The manner in which this module may be executed to perform the adversarial-based data forgetting process described herein is explained further with respect to FIGS. 1-4.

It is to be understood that the block diagram of FIG. 5 is not intended to indicate that the computing system 500 is to include all of the components shown in FIG. 5. Rather, the computing system 500 can include fewer or additional components not illustrated in FIG. 5 (e.g., additional processors, additional memory components, embedded controllers, additional modules, additional network interfaces, etc.). Furthermore, any of the functionalities relating to the adversarial-based data forgetting process described herein are partially, or entirely, implemented in hardware and/or in the processor 502. For example, such functionalities may be implemented with an ASIC, logic implemented in an embedded controller, and/or in logic implemented in the processor 502, among others. In some embodiments, the functionalities relating to the adversarial-based data forgetting process described herein are implemented with logic, wherein the logic, as referred to herein, can include any suitable hardware (e.g., a processor, among others), software (e.g., an application, among others), firmware, or any suitable combination of hardware, software, and firmware.

The present techniques may be a computing system, a method, and/or a computer program product. The computer program product may include a computer-readable storage medium (or media) having computer-readable program instructions thereon for causing a processor to carry out aspects of the present techniques.

Aspects of the present techniques are described herein with reference to flowchart illustrations and/or block diagrams of methods, apparatus (systems), and computer program products according to embodiments of the present techniques. It will be understood that each block of the flowchart illustrations and/or block diagrams, and combinations of blocks in the flowchart illustrations and/or block diagrams, can be implemented by computer-readable program instructions.

The flowchart and block diagrams in the figures illustrate the architecture, functionality, and operation of possible implementations of systems, methods, and computer program products according to various embodiments of the present techniques. In this regard, each block in the flowchart or block diagrams may represent a module, segment, or portion of instructions, which includes one or more executable instructions for implementing the specified logical functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special-purpose hardware-based systems that perform the specified functions or acts or carry out combinations of special-purpose hardware and computer instructions.

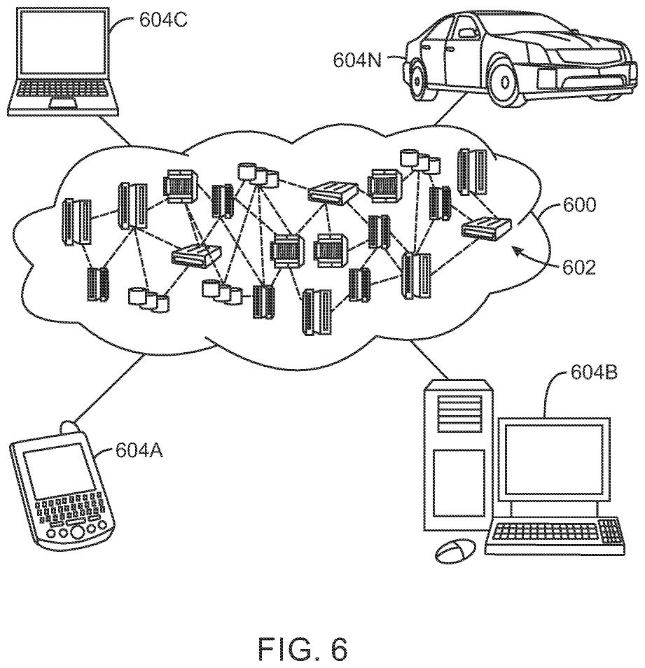

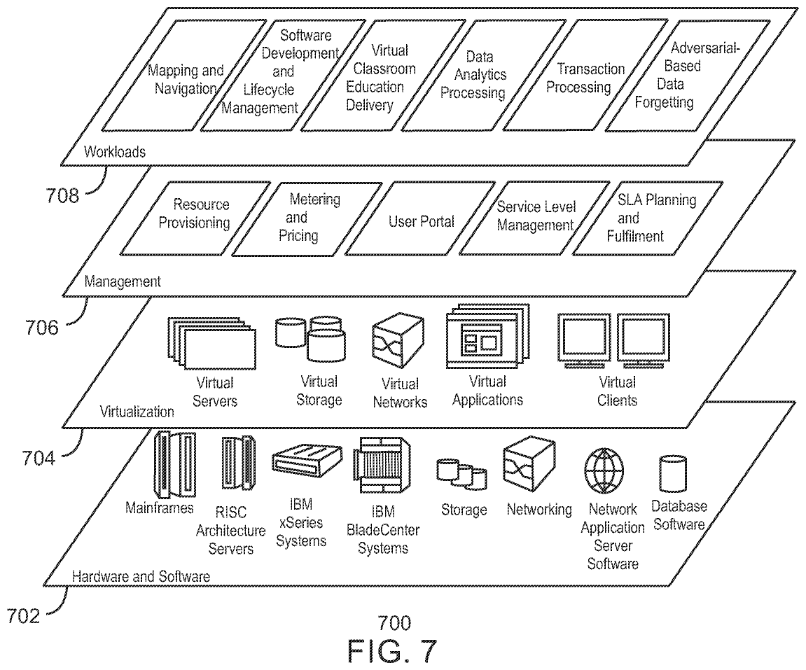

In some scenarios, the adversarial-based data forgetting techniques described herein may be implemented in a cloud computing environment, as described in more detail with respect to FIGS. 6 and 7. It is understood in advance that although this disclosure may include a description of cloud computing, implementation of the techniques described herein is not limited to a cloud computing environment. Rather, embodiments of the present techniques are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing units, memory, storage devices, applications, virtual machines, and services) that can be rapidly provisioned and released with minimal management effort or interaction with a provider of the service. This cloud model may include at least five characteristics, at least three service models, and at least four deployment models.

The at least five characteristics are as follows:

(1) On-demand self-service: A cloud consumer can unilaterally provision computing capabilities, such as server time and network storage, as needed automatically without requiring human interaction with the service's provider.

(2) Broad network access: Capabilities are available over a network and accessed through standard mechanisms that promote use by heterogeneous thin or thick client platforms (e.g., mobile phones, laptops, and PDAs).

(3) Resource pooling: The provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

(4) Rapid elasticity: Capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

(5) Measured service: Cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

The at least three service models are as follows:

(1) Software as a Service (SaaS): The capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

(2) Platform as a Service (PaaS): The capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

(3) Infrastructure as a Service (IaaS): The capability provided to the consumer is to provision processing, storage, networks, and other fundamental computing resources, where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

The at least four deployment models are as follows:

(1) Private cloud: The cloud infrastructure is operated solely for an organization. It may be managed by the organization or a third party and may exist on-premises or off-premises.

(2) Community cloud: The cloud infrastructure is shared by several organizations and supports a specific community that has shared concerns (e.g., mission, security requirements, policy, and compliance considerations). It may be managed by the organizations or a third party and may exist on-premises or off-premises.

(3) Public cloud: The cloud infrastructure is made available to the general public or a large industry group and is owned by an organization selling cloud services.

(4) Hybrid cloud: The cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure including a network of interconnected nodes.

FIG. 6 is a schematic view of an exemplary cloud computing environment 600 that can be used to implement the adversarial-based data forgetting techniques described herein. As shown, cloud computing environment 600 includes one or more cloud computing nodes 602 with which local computing devices used by cloud consumers, such as, for example, personal digital assistant (PDA) or cellular telephone 604A, desktop computer 604B, laptop computer 604C, and/or automobile computer system 604N may communicate. The cloud computing nodes 602 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 604A-N shown in FIG. 6 are intended to be illustrative only and that the cloud computing nodes 602 and cloud computing environment 600 can communicate with any type of computerized device over any type of network and/or network addressable connection (e.g., using a web browser).

FIG. 7 is a simplified schematic view of exemplary functional abstraction layers 700 provided by the cloud computing environment 600 shown in FIG. 6 according to embodiments described herein. It should be understood in advance that the components, layers, and functions shown in FIG. 7 are intended to be illustrative only and embodiments of the present techniques are not limited thereto. As depicted, the following layers and corresponding functions are provided.

Hardware and software layer 702 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 704 provides an abstraction layer from which the following examples of virtual entities may be provided: virtual servers; virtual storage; virtual networks, including virtual private networks; virtual applications and operating systems; and virtual clients. In one example, management layer 706 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources include application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 708 provides examples of functionality for which the cloud computing environment may be utilized. Examples of workloads and functions which may be provided from this layer include the following: mapping and navigation; software development and lifecycle management; virtual classroom education delivery; data analytics processing; transaction processing; and executing adversarial-based data forgetting techniques.

The system(s), method(s), and computer program product(s) described herein provide a technical solution to the technical problem of accurately classifying and/or detecting target objects within images using a classification/detection model. This may be particularly useful in the application domain of identifying retail products in an image, such as, for example, identifying multiple instances of specific retail products on multiple shelves. In addition, the system(s), method(s), and computer program product(s) described herein improve the performance of a computing device that identifies target objects within images by reducing the data storage requirements and/or reducing the computational difficulty (in terms of processor utilization and/or processing time) for identifying such target objects. Furthermore, the system(s), method(s), and computer program product(s) described herein improve an underlying technical process within the field of image processing, in particular, within the field of automatic detection and recognition of target objects within images.

The system(s), method(s), and computer program product(s) described herein are tied to physical real-life components, including, for example, a camera that captures images and a data storage device that stores a repository of data relating to classification/detection models. Accordingly, the system(s), method(s), and computer program product(s) described herein are inextricably tied to computing technology and/or physical components to overcome an actual technical problem arising in the processing of digital images.

The descriptions of the various embodiments of the present techniques have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for forgetting data samples from a pretrained neural network model, comprising:
receiving, at a computing system, a pretrained neural network model, training data samples corresponding to a training dataset for the pretrained neural network model, test data samples corresponding to a test dataset, and data samples to be forgotten from the pretrained neural network model;
training an adversarial model to classify the training data samples as members of the pretrained neural network model and the test data samples as non-members of the pretrained neural network model; and
performing the following in an iterative manner until the pretrained neural network model has forgotten at least a specified threshold of the data samples to be forgotten:
classifying each data sample as either a member or a non-member of the pretrained neural network model using the trained adversarial model;
for the data samples that are classified as members of the pretrained neural network model, determining a subset of the data samples that comprises data samples to be forgotten;
performing the following for the subset of the data samples that comprises data samples to be forgotten:
labeling each data sample within the subset of data samples as a non-member; and
updating the pretrained neural network model based on weight update techniques that cause the pretrained neural network model to forget the data samples within the subset of data samples;
retraining the pretrained neural network model using at least a portion of the training data samples without the data samples that have been forgotten; and
retraining the adversarial model to classify the training data samples without the data samples that have been forgotten as members of the pretrained neural network model and the test data samples as non-members of the pretrained neural network model.

2. The method of claim 1, comprising training and retraining the adversarial model using attributes extracted from the pretrained neural network model.

3. The method of claim 2, wherein training and retraining the adversarial model using the attributes extracted from the pretrained neural network model comprises:
extracting at least one of logits and/or probabilities from a last layer of the pretrained neural network model, activation from any layer of the pretrained neural network model, or weights and/or gradients from the pretrained neural network model; and
using the at least one of the extracted logits and/or probabilities, activation, or weights and/or gradients to train the adversarial model.

4. The method of claim 1, wherein classifying each data sample as either a member or a non-member of the pretrained neural network model using the trained adversarial model comprises performing the following for each data sample:
extracting features of the data sample;
utilizing the adversarial model to determine whether the features of the data sample correspond to the training data samples;
if the features of the data sample do not correspond to the training data samples, classifying the data sample as a non-member of the pretrained neural network model; and
if the features of the data sample do correspond to the training data samples, classifying the data sample as a member of the pretrained neural network model.

5. The method of claim 1, comprising retraining the pretrained neural network model using additional data samples that are similar to the training data samples, either alone or in combination with at least a portion of the training data samples without the data samples that have been forgotten.

6. The method of claim 1, comprising:
predetermining the specified threshold of the data samples to be forgotten; or
determining the specified threshold of the data samples to be forgotten based on a classification distribution of the test data samples by the adversarial model.

7. The method of claim 1, comprising classifying each data sample, determining the subset of the data samples, and performing the labeling of each data sample and the updating of the pretrained neural network model in a repetitive manner on batches of data samples, wherein each batch of data samples comprises any combination of training data samples, test data samples, and data samples to be forgotten.

8. A computing system, comprising:
an interface for receiving a pretrained neural network model, training data samples corresponding to a training dataset for the pretrained neural network model, test data samples corresponding to a test dataset, and data samples to be forgotten from the pretrained neural network model;
a processor; and
a computer-readable storage medium storing program instructions that direct the processor to:
train an adversarial model to classify training data samples as members of the pretrained neural network model and test data samples as non-members of the pretrained neural network model; and
perform the following in an iterative manner until the pretrained neural network model has forgotten at least a specified threshold of the data samples to be forgotten:
classify each data sample as either a member or a non-member of the pretrained neural network model using the trained adversarial model;
for the data samples that are classified as members of the pretrained neural network model, determine a subset of the data samples that comprises data samples to be forgotten;
perform the following for the subset of the data samples that comprises data samples to be forgotten:
label each data sample within the subset of data samples as a non-member; and
update the pretrained neural network model based on weight update techniques that cause the pretrained neural network model to forget the data samples within the subset of data samples;
retrain the pretrained neural network model using at least a portion of the training data samples without the data samples that have been forgotten; and
retrain the adversarial model to classify the training data samples without the data samples that have been forgotten as members of the pretrained neural network model and the test data samples as non-members of the pretrained neural network model.

9. The computing system of claim 8, wherein the computer-readable storage medium stores program instructions that direct the processor to train and retrain the adversarial model using attributes extracted from the pretrained neural network model.

10. The computing system of claim 9, wherein the computer-readable storage medium stores program instructions that direct the processor to train and retrain the adversarial model using the attributes extracted from the pretrained neural network model by:
extracting at least one of logits and/or probabilities from a last layer of the pretrained neural network model, activation from any layer of the pretrained neural network model, or weights and/or gradients from the pretrained neural network model; and
using the at least one of the extracted logits and/or probabilities, activation, or weights and/or gradients to train the adversarial model.

11. The computing system of claim 8, wherein the computer-readable storage medium stores program instructions that direct the processor to classify each data sample as either a member or a non-member of the pretrained neural network model using the trained adversarial model by performing the following for each data sample:
extracting features of the data sample;
utilizing the adversarial model to determine whether the features of the data sample correspond to the training data samples;
if the features of the data sample do not correspond to the training data samples, classifying the data sample as a non-member of the pretrained neural network model; and
if the features of the data sample do correspond to the training data samples, classifying the data sample as a member of the pretrained neural network model.

12. The computing system of claim 8, wherein the computer-readable storage medium stores program instructions that direct the processor to retrain the pretrained neural network model using additional data samples that are similar to the training data samples, either alone or in combination with at least a portion of the training data samples without the data samples that have been forgotten.

13. The computing system of claim 8, wherein the computer-readable storage medium stores program instructions that direct the processor to:
predetermine the specified threshold of the data samples to be forgotten; or
determine the specified threshold of the data samples to be forgotten based on a classification distribution of the test data samples by the adversarial model.

14. The computing system of claim 8, wherein the computer-readable storage medium stores program instructions that direct the processor to classify each data sample, determine the subset of the data samples, and perform the labeling of each data sample and the updating of the pretrained neural network model in a repetitive manner on batches of data samples, wherein each batch of data samples comprises any combination of training data samples, test data samples, and data samples to be forgotten.

15. A computer program product, comprising a computer-readable storage medium having program instructions embodied therewith, wherein the computer-readable storage medium is not a transitory signal per se, and wherein the program instructions are executable by a processor to cause the processor to:
access a pretrained neural network model, training data samples corresponding to a training dataset for the pretrained neural network model, test data samples corresponding to a test dataset, and data samples to be forgotten from the pretrained neural network model;
train an adversarial model to classify training data samples as members of the pretrained neural network model and test data samples as non-members of the pretrained neural network model; and
perform the following in an iterative manner until the pretrained neural network model has forgotten at least a specified threshold of the data samples to be forgotten:
classify each data sample as either a member or a non-member of the pretrained neural network model using the trained adversarial model;
for the data samples that are classified as members of the pretrained neural network model, determine a subset of the data samples that comprises data samples to be forgotten; and
perform the following for the subset of the data samples that comprises data samples to be forgotten:
label each data sample within the subset of data samples as a non-member; and
update the pretrained neural network model based on weight update techniques that cause the pretrained neural network model to forget the data samples within the subset of data samples;
retrain the pretrained neural network model using at least a portion of the training data samples without the data samples that have been forgotten; and
retrain the adversarial model to classify the training data samples without the data samples that have been forgotten as members of the pretrained neural network model and the test data samples as non-members of the pretrained neural network model.

16. The computer program production of claim 15, wherein the program instructions are executable by the processor to cause the processor to train and retrain the adversarial model using attributes extracted from the pretrained neural network model.

17. The computer program production of claim 16, wherein the program instructions are executable by the processor to cause the processor to train and retrain the adversarial model using the attributes extracted from the pretrained neural network model by:
extracting at least one of logits and/or probabilities from a last layer of the pretrained neural network model, activation from any layer of the pretrained neural network model, or weights and/or gradients from the pretrained neural network model; and
using the at least one of the extracted logits and/or probabilities, activation, or weights and/or gradients to train the adversarial model.

18. The computer program production of claim 15, wherein the program instructions are executable by the processor to cause the processor to classify each data sample as either a member or a non-member of the pretrained neural network model using the trained adversarial model by performing the following for each data sample:
extracting features of the data sample;
utilizing the adversarial model to determine whether the features of the data sample correspond to the training data samples;
if the features of the data sample do not correspond to the training data samples, classifying the data sample as a non-member of the pretrained neural network model; and
if the features of the data sample do correspond to the training data samples, classifying the data sample as a member of the pretrained neural network model.

19. The computer program production of claim 15, wherein the program instructions are executable by the processor to cause the processor to retrain the pretrained neural network model using additional data samples that are similar to the training data samples, either alone or in combination with at least a portion of the training data samples without the data samples that have been forgotten.

20. The computer program production of claim 15, wherein the program instructions are executable by the processor to cause the processor to:
predetermine the specified threshold of the data samples to be forgotten; or
determine the specified threshold of the data samples to be forgotten based on a classification distribution of the test data samples by the adversarial model.
